(19) United States
(12) Patent Application Publication
(10) Pub. No.: US 2007/0056837 A1
(43) Pub. Date: Mar. 15, 2007

(54) Air blown electric switch device

(75) Inventor: Chung Jen Chiu, Taipei (TW)

Correspondence Address: HDSL, 4331 STEVENS BATTLE LANE, FAIRFAX, VA, 22033, US

(73) Assignee: Chih Pang Chou

(21) Appl. No.: 11/325,542

(22) Filed: Jan. 5, 2006

(30) Foreign Application Priority Data
Sep. 9, 2005 (TW) 094215579

(51) Int. Cl. H01H 35/26; H01H 35/24

(52) U.S. Cl. 200/81 R

(57) ABSTRACT

An air blown electric switch device suitable for an electric device includes a body, a pressure detector, and controlling circuits. The pressure detector is installed inside the body for detecting a pressure and generating a pressure signal according to the pressure. The controlling circuits are installed inside the body and connected with the electric device and the pressure detector for receiving the pressure signal and controlling the electric device to turn on or turn off.

### BACKGROUND OF THE INVENTION

1. Field of the Invention

The present invention relates to an air blown electric switch device, and particularly relates to an air blown electric switch device, which is controlled by detecting the pressure.

2. Description of Related Art

Conventionally, switches of electric devices, such as lamp, are mechanical components. The conventionally mechanical switches are mainly divided into two types. One is switched by pressing. When a conductive component is pressed up or down, circuits nearby the conductive componet are switched to be turned on or turned off, such as membrance switches. The other is a guillotine switch, which is controlled by changing the angle of the switching component. It is commonly used and installed on the walls to switch illuminatning device.

However, all the conventionally mechanical switches are manual control switches, such that there must be sufficient spaces for an operator to controll the swithces. Furthermore, the conventionally mechanical switches are continuing touched by operators, such that the switches may be smudged by operators' dirty hands. It may cause healthy problems. Thus, it does not fill the bill of nowdays that the conventional switches are controlled by touching.

### SUMMARY OF THE INVENTION

The present invention is to provide an air blown electric switch device, which is controlled by detecting pressure, so as to overcome the problems mentioned above.

The present invention is to provide an air blown electric switch device, so as to avoid virus infection by touching.

The present invention is to provide an air blown electric switch device, which is applied in a lamp, a fan, or a motor . . . etc. The air blown electric switch device includes a body, a pressure detector, and controlling circuits.

The pressure detector is installed inside the body for detecting a pressure and generating a pressure signal according to the pressure. The controlling circuits are installed inside the body and connected with the electric device and the pressure detector for receiving the pressure signal and controlling the electric device to turn on or turn off.

### BRIEF DESCRIPTION OF THE DRAWINGS

FIG. 1 is a block diagram illustrating an air blown electric switch device of the present invention;

FIG. 2A is a schematic drawing showing the air blown electric switch device applied in an electric candle in the turned on situation according to a first embodiment of the present invention;

FIG. 2B is a schematic drawing showing the air blown electric switch device applied in an electric candle in the turned off situation according to a first embodiment of the present invention;

FIG. 3A is a schematic drawing showing the air blown electric switch device applied in a lamp in the turned on situation according to a second embodiment of the present invention; and

FIG. 3B is a schematic drawing showing the air blown electric switch device applied in a lamp in the turned off situation according to a second embodiment of the present invention.

### DETAILED DESCRIPTION OF THE PREFERRED EMBODIMENT

The following provides exemplary embodiments of the present invention with reference to the accompanying drawings.

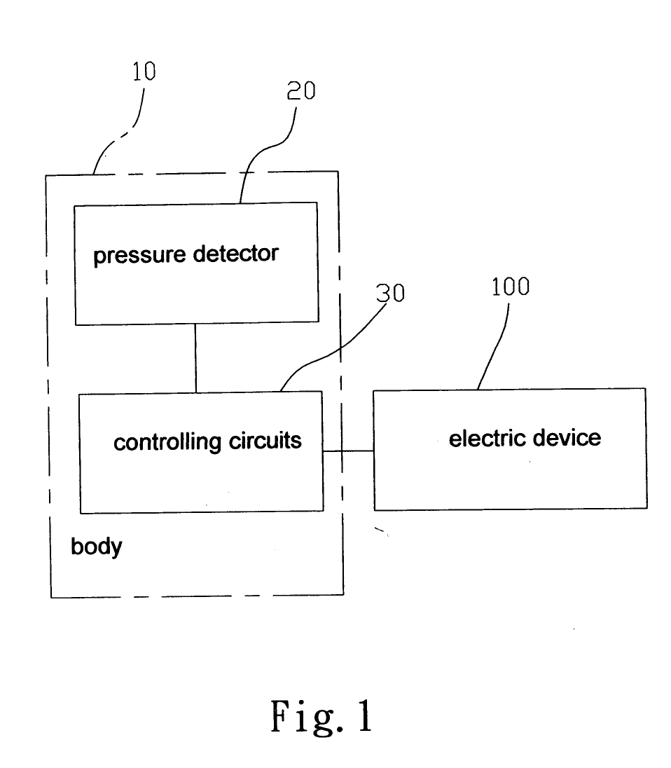

In FIG. 1, according to the embodiment the present invention, an air blown electric switch device suitable for an electric device 100 is provided.

For example, the electric device 100 can be a home appliance likely to be a fan, illuminating devices likely to be a lamp, or a motor . . . etc. The air blown electric switch device comprises a body 10, a pressure detector 20, and controlling circuits 30. The pressure detector 20 for sensing the pressure of the air to generate a pressure signal can be installed inside or outside the body 10. The controlling circuits 30 for connecting the electric device 100 with the pressure detector 20 and receiving the pressure signal from the pressure detector 20 is installed inside the body 10. The pressure signal is transferred into a voltage signal for switching the electric device 100 to turn on or off by the controlling circuits 30.

Next, according to an embodiment of the present invention, the electric device 100 is preferably taken an example to be an electric candle or a lamp. The air blown electric switch device is applied in the electric candle or the lamp.

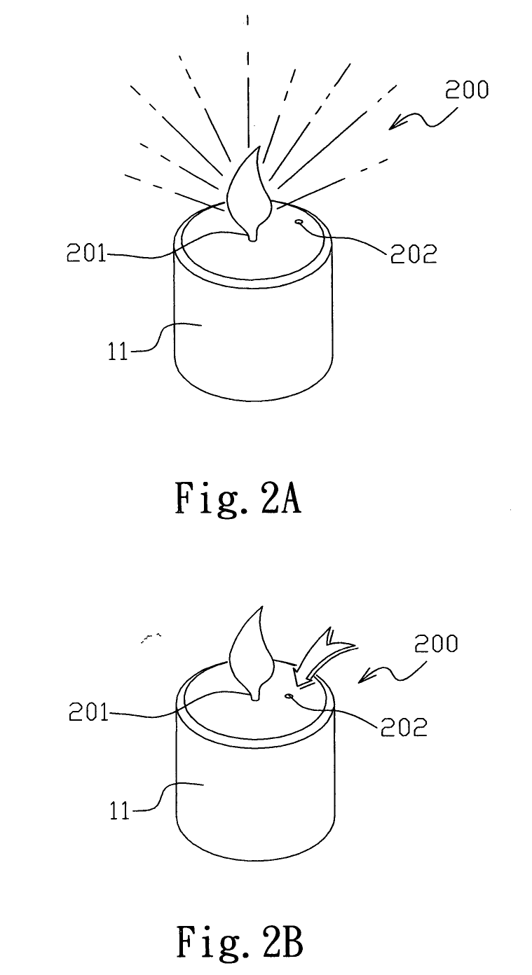

In FIGS. 2A and 2B, according to the first embodiment, the air blown electric switch device is suitable for an electric candle 200. A light emitting diode 201 setting on the top of a body 11 of the electric candle 200 is shaped into a shape of a flame. Air blown holes 202 formed surrounding the light emitting diode 201 is connected with the pressure detector. The pressure detector and the controlling circuits are connected, and the light emitting diode 201 and the controlling circuits are connected (not shown). The locations related to the pressure detector and the controlling circuits are the same as what shows in FIG. 1 and well known by anyone who is skilled in the field. When the air blown electric switch device is turned on, if air is blown into the air blown holes 202, the air is detected by the pressure detector under the air blown holes 202. A pressure signal, then, is generated by the pressure detector and delivered to the controlling circuits. The pressure signal is transferred into a voltage signal by the controlling circuits. After the voltage signal is generated, the light emitting diode 201 is turned on, and the electric candle 200 is lighted (FIG. 2A). If air is again blown into the air blown holes 202, the air is also detected by the pressure detector. A more pressure signal is generated by the pressure detector and delivered to the controlling circuits. The pressure signal is transferred into a voltage signal by the controlling circuits. After the voltage signal is generated, the light emitting diode 201 is turned off, and the electric candle 200 is snuffed out (FIG. 2B).

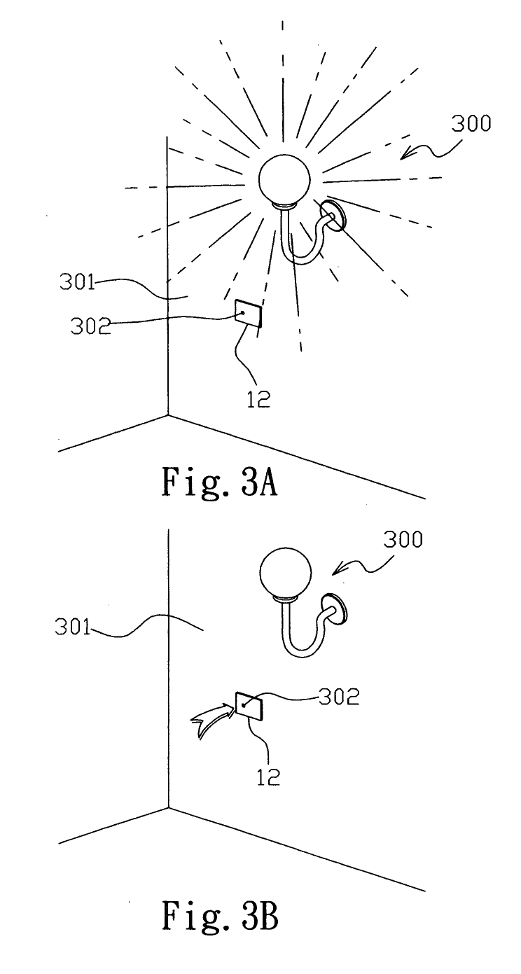

In FIGS. 3A and 3B, according to the second embodiment, the air blown electric switch device is suitable for a lamp 300. A body 12 is installed on the wall 301. An air blown hole 302 formed through the wall 301 is connected with the pressure detector 22 installed inside the body 12. The pressure detector 22 and the controlling circuits are connected, and the lamp 300 and the controlling circuits are connected (not shown). The locations related to the pressure detector and the controlling circuits are the same as what shows in FIG. 1 and well known by anyone who is skilled in the field. When the air blown electric switch device is turned on, if air is blown into the air blown hole 302, the air is detected by the pressure detector 22. Similar to the first embodiment, the lamp 300 is lighted (FIG. 3A). If air is again blown into the air blown hole 302, the lamp 300 is turned off (FIG. 2B). The operation can be continuing recycled.

According to these embodiments of the present, the diameter of the air blown holes is preferably less than 3 mm, so as to gather the pressure up without extra influence of other air flow. Specifically, a threshold pressure can be set according to the embodiment of the present invention. If the pressure detected by the pressure detector is higher than the threshold pressure, the pressure signal would be generated. Therefore, in the manner, the electric device can not be bothered any extra air flow. The utility of the air blown electric switch device can be improved.

According to the present invention, the air blown electric switch device is controlled by pressure, and the electric device is further controlled by the air blown electric switch device. It is easy for an operator to blow an air to switch the electric device. The air blown electric switch device of the present invention takes several advantages. The volume of the air blown electric switch device is small. The current consuming is saved, for example, the static current is about 250 μA/4.5 V. The life of the air blown electric switch device can be prolong, and getting an electric shock can be avoided, due to no hand touching. Furthermore, if the air blown electric switch device is installed in a public place, the way of viruses' infection by touching can be avoided.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An air blown electric switch device, suitable for an electric device, comprising:
a body having an air blown hole;
a pressure detector for detecting a pressure when a user blows air into the air blown hole and generating a pressure signal according to the pressure; and
controlling circuits, installed inside the body, connected with the electric device and the pressure detector, for receiving the pressure signal and controlling the electric device to turn on or turn off.

2. The air blown electric switch device as claimed in claim 1, wherein the body is shaped into a shape of a flame.

3. The air blown electric switch device as claimed in claim 1, wherein the pressure signal is generated when the pressure detected by the pressure detector is higher than a threshold pressure.

4. The air blown electric switch device as claimed in claim 1, wherein the electric device is turned on and turned off in sequence when a plurality of the pressure signals are sent to the controlling circuits.

5. The air blown electric switch device as claimed in claim 1, wherein the pressure detector is installed inside the body.

6. Amended) The air blown electric switch device as claimed in claim 5, wherein the air blown hole is formed on a top surface of the body.

7. The air blown electric switch device as claimed in claim 6, wherein the diameter of the air blown hole is less than 3 mm.

8. The air blown electric switch device as claimed in claim 6, wherein the air blown hole is connected with the pressure detector.

9. An electric candle comprising:
a cylindrical body having an air blown hole formed on top surface thereof;
a flame-shaped light emitting diode (LED) setting on top of the cylindrical body;
a pressure detector installed inside the cylindrical body and connected to the air blown hole, for detecting a pressure when a user blows air into the air blown hole and generating a pressure signal according to the pressure; and
controlling circuits, installed inside the body, connected with the LED and the pressure detector, for receiving the pressure signal and controlling the LED to turn on or turn off.

10. The air blown electric switch device as claimed in claim 9, wherein the pressure signal is generated when the pressure detected by the pressure detector is higher than a threshold pressure.

11. The air blown electric switch device as claimed in claim 9, wherein the electric device is turned on and turned off in sequence when a plurality of the pressure signals are sent to the controlling circuits.

12. The air blown electric switch device as claimed in claim 9, wherein the diameter of the air blown hole is less than 3 mm.
